(19) United States
(12) Patent Application Publication
(10) Pub. No.: US 2006/0169951 A1
(43) Pub. Date: Aug. 3, 2006

(54) Transparent polycrystalline aluminium oxide

(75) Inventors: Michel Paul Barbara Van Bruggen, Eindhoven (NL); Theo Arnold Kop, Eindhoven (NL); Theodora Antonia Petra Maria Keursten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Ewindhoven (NL)

(21) Appl. No.: 10/520,311

(22) PCT Filed: Jun. 25, 2003
(86) PCT No.: PCT/IB03/02874

§ 371 Date: Jan. 5, 2005

(30) Foreign Application Priority Data
Jul. 10, 2002 (EP) 020777835

(51) Int. Cl. H01B 1/12

(52) U.S. Cl. 252/500

(57) ABSTRACT

The invention relates to highly dense transparent aluminum oxide (alumina) and structures thereof for applications where, e.g. in the lighting industry, a fine crystal size has to be obtained and stabilized for use at temperatures of 800° C. or more. The invention also relates to an electric lamp having a discharge tube with a wall of such a ceramic. The alumina according to the invention is provided with an additive and has an average crystal size=2 μm, and a relative density higher than 99.95% with a real in-line transmission RIT=30%, preferably >40% and more preferably >50%, measured over an angular aperture of at most 0.50 at a sample thickness of 0.8 mm and with a single wave-length of light λ of preferably 645 nm, and the additive comprises at least one of the substances from the group consisting of oxides of Mg, Y, Er and La.

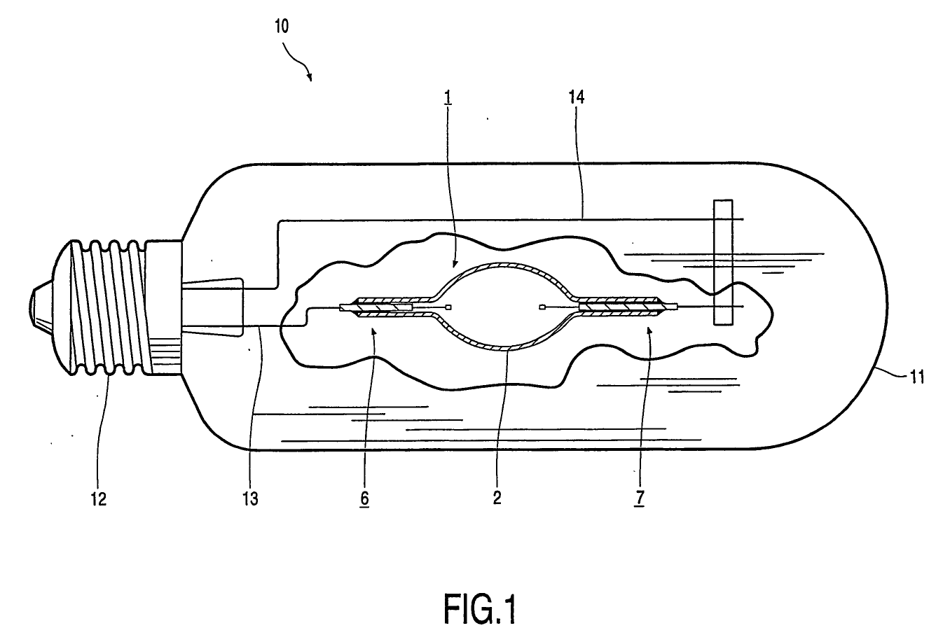

The invention relates to highly dense transparent aluminum oxide and structures thereof for applications where, e.g. in the lighting industry, a fine crystal size has to be obtained and stabilized for use at temperatures of 800° C. or more. The invention also relates to an electric lamp having a discharge tube with a wall of such a ceramic.

Sintered transparent alumina ceramics consisting of a chemically and thermodynamically stable corundum phase (α-Al₂O₃) have been available for several decades. Traditionally, they are produced from very fine-grained transitional alumina raw powders and obtain a high sintering density by annealing at very high temperatures >1600° C. As a result, the ceramic microstructures are coarse with crystal sizes typically >15 μm. As a consequence of this coarse microstructure, these materials exhibit, even in thin components, only translucency but no transparency. Besides, the known ceramics have a relatively low bending strength, usually less than 300 MPa.

Transparency of a ceramic component is to be taken to mean herein that said ceramic component has a value for real in-line transmission RIT of at least 30%, the real in-line transmission RIT being measured over an angular aperture of at most 0.5° at a sample thickness of 0.8 mm and with a monochromatic wavelength of light λ.

In literature optical properties are commonly characterized by using total forward transmission (TFT) and in-line transmission (IT), the latter being measured with commercially available spectrometers. As these have angular apertures of several degrees, the IT thus measured includes a large amount of forward scattered light. As a consequence, for scattering samples, both TFT and IT will always result in values that are much higher than the RIT value for the same sample. It is not possible to establish any quantitative relationship with the RIT. It is possible, however, to compare real in-line transmission values which have been taken from samples with a thickness other than 0.8 mm as defined above. For a sample 1 of thickness d1 and RIT value T1 and a second sample having a thickness d2, the value T2 of the RIT satisfies the relation
T2=(1−R)*[T1/(1−R)]^{d2/d1} (1)
where R is the coefficient of surface reflection which for alumina is 0.14 (incorporating the reflection on both surfaces). Due to reflection losses a transmission value, either RIT, TFT or IT, cannot exceed a value of 86%.

The inventors have established that for a ceramic sample having a very small porosity as well as small pores, i.e. at least smaller than 0.01% and <100 nm, respectively, the real in-line transmission RIT is correlated to the sample's structure. When measured according to the above-stated definition, the RIT obtained can be expressed as,

$$RIT = ( 1 - R ) exp ( - \frac{3 {π}^{2} Gd Δ {n}^{2}}{2 {λ}_{0}^{2}} ) , \qquad ( 2 )$$

where R is the coefficient of surface reflection (0.14 for Al₂O₃), d is the sample thickness, G is the average crystal size, Δn is the effective birefringence of alpha-alumina (0.005) calculated as the weighted average of the refractive index differences between each of the main optical axes, and λ₀ is the wavelength of the monochromatic incident light in vacuum. At higher porosity percentages and larger pore sizes, the measured RIT results in significantly smaller values than those predicted by the above expression.

It has been proposed to obtain translucent sintered products with fine crystal sizes of 2-5 μm by applying a slip casting approach in combination with pressureless pre-sintering and hot-isostatic post-densification (HIP). No RIT was measured on a test sample but the maximum IT was 46% (at 1 mm sample thickness, visible with infrared light—no wave-length given) observed at an average crystal size of 5 μm.

Only slight improvements were observed when the crystal sizes are reduced towards the sub-micrometer range. Dense samples produced with an average crystal size of 0.82 μm by injection moulding, pre-sintering and HIP were reported to have an IT (at 500 nm wavelength) of 78%, recorded at a sample thickness of 0.5 mm thickness.

The purity of the alumina in these cases was reported to be 99.99%. The above-mentioned HIP process was carried out at a temperature of about 1250 to 1280° C., giving rise to an additional difficulty, however, because if the ceramics are intended for use in a discharge lamp, a discharge tube of such a discharge lamp is operated at temperatures ranging from 1100 to 1300° C. Any technical use of these sintered products at temperatures similarly high or even higher than the HIP temperatures will unavoidably coarsen the above-described highly pure alumina microstructures. Whereas several additives like for instance MgO and ZrO₂ have been reported to retard crystal growth in annealing alumina ceramics, the precise effects are often unclear.

According to EP 1053983, which relates to translucent polycrystalline ceramics with mean facet lengths not exceeding a maximum wavelength λ of the light (which for λ=600 nm e.g. means a crystal size of about 0.6 μm since the facet length is about half of the average crystal size), an additive of only 0.05 mol-% ZrO₂ as a sinter dopant in transparent sintered alumina ceramics has a degenerating effect on both the optical transmittance, the strength and the hardness compared to samples without ZrO₂. For 0.5 mm thin discs and λ<800 nm, the measured value for the so-termed linear transmission, which in this case can be compared to the real in-line transmission RIT, decreases to 25% compared with a measured value of 40% for a zirconia free microstructure with MgO dopant (0.1 mol-%). A RIT value of 25% for a thickness d of 0.5 mm corresponds according to the relation (1) to a value of 12% for a thickness d=0.8 mm. For the zirconia free microstructure the corresponding value for a thickness d=0.8 mm is 25%.

A transparent Al₂O₃ component with a value for the RIT of at least 30% measured over an angular aperture of at most 0.5° at a sample thickness of 0.8 mm and with a monochromatic wavelength of light λ and having an acceptable strength is therefore unknown. That is a problem. A lamp discharge vessel of transparent polycrystalline alumina, of which the small crystal structure is retained over a long period of time under lamp operation circumstances is not known either. That is also a problem. It is therefore the objective of the present invention to solve the problems and to provide a component by means of which the previously mentioned limitations are overcome.

The present invention provides a polycrystalline alumina component with an additive which is characterized in that the alumina has an average crystal size ≦2 μm, and a relative density higher than 99.95% with a real in-line transmission RIT ≧30%, preferably >40% and more preferably >50%, measured over an angular aperture of at most 0.5° at a sample thickness of 0.8 mm and with a single wavelength of light λ of preferably 645 nm, and that the additive comprises at least one of the substances from the group consisting of oxides of Mg, Y, Er and La.

The resultant RIT value >30% and a fine crystal size ≦2 μm or, preferably ≦1 μm, which turns out to be stabilized for longer periods when the component is used at temperatures of 800° C. or more upon high-temperature annealing, is surprising and clearly in disagreement with the previous state of the art. This is made possible here by the combination of very small crystal sizes and an extremely high relative density >99.95%, implying a very small residual porosity.

Preferably an alumina component according to the invention is made according to the process described hereafter. An aqueous slurry with a solid loading of 41 wt-% was prepared at pH=9 from TM-DAR corundum powder [average particle size 0.2 μm; make Boehringer Ingelheim Chemicals, Japan] without any further additives. A high degree of dispersion was obtained after at least 1 day of ultrasound or at least half a day of wet ball milling, using milling beads that could not give rise to contaminations other than alumina or wear which can be oxidized. An additive or dopant selected from the group formed by oxides of Mg, Y, Er and La was then introduced by the addition of pure and finely grained oxide powder of the said dopant. The average particle size of the dopant or additive is preferably chosen smaller than the alumina crystal size obtained after sintering and HIP treatment. Alternatively the additive or dopant can be introduced by a precursor containing one or more of the elements Mg, Y, Er and La. Reference samples without additive were prepared in the same way, except that no dopant was added.

The suspensions thus obtained were, without further degassing, either pressure cast at a pressure of 4 bar using a Millipore hydrophilic membrane with an average pore diameter of 50 nm, or slip cast on a porous mould with an average porosity of about 50% and an average pore size of about 100 nm. After consolidation the pellets were dried in air for about 4 hours and subsequently further dried in a stove at a temperature of 80° C. for more than 4 hours. The dried compacts were calcined at 600° C. for 2 hours in pure oxygen to remove impurities. Hereafter the pellets were sintered at a sinter temperature (Ts) ranging from 1150° C. to 1350° C. in either oxygen, vacuum or humidified hydrogen (dew point 0° C.). Pellets with a density higher than 96% were given a subsequent HIP treatment at a temperature of 1200° C. and a pressure of 200 Mpa for at least 2 hours. The pellets were ground on both parallel sides, first with successively finer diamond grains of finally 3 μm. The final thickness of the discs was 0.8 mm.

The real in-line transmission (RIT) of the samples thus formed was measured using a red diode laser with a wavelength λ of 645 nm and a detector at a distance from the illuminated sample of at least 1 meter to ensure an angular aperture of 0.5°. Also the total forward transmission (TFT) was measured. In a number of cases the absorption (ABS), the total reflection (TR) and the density after sintering (C) was measured. The results are shown in Table I.

TABLE I

| | | Sinter | | | |
|---|---|---|---|---|---|
| MgO (ppm) | Ts (° C.) | atmosphere | RIT | TFT | ABS |
| 133 | 1200 | O₂ | 54 | 76 | 6 |
| 300 | 1200 | O₂ | 55 | 76 | 6 |
| 1000 | 1220 | O₂ | 45 | 72 | 6 |
| 133 | 1200 | H₂ | 44 | 65 | 17 |
| 300 | 1200 | H₂ | 46 | 67 | 17 |
| 1000 | 1220 | H₂ | 45 | 67 | 16 |

| Y₂O₃ (ppm) | Ts (° C.) | ρ (%) | RIT | TFT | ABS |
|---|---|---|---|---|---|
| 100 | 1245 | 96.5 | 61.1 | 76.1 | 9.6 |
| | 1250 | 99.2 | 58.3 | 77.0 | 8.4 |
| | 1300 | 100 | 54.3 | 76.2 | 9.2 |
| 400 | 1285 | 98.2 | 62.0 | 75.8 | 9.9 |
| | 1300 | 99.8 | 62.4 | 75.3 | 10.3 |
| 1000 | 1300 | 96.5 | 66.3 | 73.7 | 12.2 |
| | 1330 | 99.0 | 46.1 | 67.2 | 16.7 |

| Er₂O₃ | | | | | |
|---|---|---|---|---|---|
| (ppm)_sinter | | | | | |
| atmosphere | Ts (° C.) | ρ (%) | RIT | TFT | ABS |
| 350_H₂ | 1235 | 97.0 | 61.0 | 76.6 | 9.3 |
| | 1280 | 98.0 | 57.9 | 75.4 | |
| | 1290 | 98.4 | 57.0 | 75.1 | 10.7 |
| 50 + 300 ppm | 1260 | 98.3 | 57.3 | 76.0 | |
| MgO_H₂ | | | | | |
| 350_O₂ | 1275 | 97.0 | 60.6 | 82.5 | |
| 50 + 300 ppm | 1250 | 98.4 | 61.0 | 82.3 | 2.6 |
| MgO_O₂ | | | | | |

| 1200 ppm La₂O₃ | | | | | |
|---|---|---|---|---|---|
| Tsinter (° C.)_{—} | | | | | |
| Sinter | | | | | |
| atmosphere | ρ (%) | RIT | TFT | TR | ABS |
| 1270_O₂ | 98.7 | 71.3 | 80.6 | 15.1 | 4.3 |

For the examples having La₂O₃ as an additive, the HIP was performed at 1250° C. for 6 hours. Influences of annealing treatments (annealing time t in hours and annealing temperature in ° C.) on crystal size structure is shown in Table II. The sample indicated as Reference in Table II is formed of alumina without an additive or dopant.

TABLE II
Crystal size (micron; μm)

| | | |
|---|---|---|
| Dopant | 1250° C. | 1300° C. |

| (ppm) | t = 0 h | 2 h | 12 h | 24 h | 48 h | 96 h | 192 h | 24 h | 48 h | 96 h |
|---|---|---|---|---|---|---|---|---|---|---|
| 0 MgO | 0.48 | | 0.91 | 1.09 | | 1.45 | | 1.89 | | |
| 133 MgO | 0.47 | 0.55 | 0.84 | 0.94 | 1.02 | 1.14 | 1.41 | 1.38 | 1.53 | 1.80 |
| 300 MgO | 0.42 | 0.51 | 0.57 | 0.79 | 1.1 | 1.06 | | | 1.35 | 2.00 |
| 1000 MgO | 0.46 | | | | | 1.26 | 1.53 | | 1.49 | 1.82 |

| | | 1250° C. | 1300° C. | 1325° C. |
|---|---|---|---|---|
| | t = 0 h | 192 h | 48 h | 24 h |
| 133 MgO | 0.47 | 1.41 | 1.53 | 1.53 |

| | After | | | | | | | | |
|---|---|---|---|---|---|---|---|---|---|
| t = 24 h | Hip | 1225° C. | 1250° C. | 1275° C. | 1300° C. | 1325° C. | 1350° C. | 1400° C. | 1450° C. |
| Reference | 0.48 | | 1.09 | 1.49 | 1.89 | | | | |
| 1200 La₂O₃ | 0.33 | | | | 0.55 | | 0.86 | 1.82 | 3.53 |
| 133 MgO | 0.48 | 0.67 | 0.94 | 0.99 | 1.41 | 1.53 | | | |
| 100 Y₂O₃ | 0.36 | | 0.64 | 0.93 | 1.01 | | 1.62 | 2.90 | 4.81 |

| | Ts | t = 0 h; | 6 h; | 24 h; | 96 h; |
|---|---|---|---|---|---|
| | (° C.) | 1400° C. | 1400° C. | 1400° C. | 1400° C. |
| 100 Y₂O₃ | 1250 | 0.57 | 1.57 | 2.90 | 3.43 |
| 1000 Y₂O₃ | 1300 | 0.36 | 1.35 | | |
| 350 Er₂O₃ | 1290 | 0.60 | 1.89 | | 3.65 |
| 50 Er₂O₃ + | 1265 | 0.54 | 1.66 | | 3.53 |
| 300 MgO | | | | | |
| 1000 MgO | 1215 | 0.46 | 1.74 | | |
| 133 MgO | 1200 | 0.47 | | 2.98 | |
| Reference | 1200 | 0.48 | | 3.53 | |

In another experiment carried out by simulation the longer term influence of increased temperature on the crystal size has been investigated. The simulation is based on the model as disclosed in J. Am. Ceram. Soc. 73(1990) 11, 3292-3301. The effect on samples having an additive of dopant from the selected group of oxides is shown in Table III.

TABLE III

| Sample and | | | | |
|---|---|---|---|---|
| temperature | 24 h | 100 h | 1000 h | 10.000 h |
| 1200 ppm La₂O₃ | | | | |
| 1100° C. | 0.33 | 0.33 | 0.33 | 0.39 |
| 1150° C. | 0.33 | 0.33 | 0.34 | 0.41 |
| 1200° C. | 0.33 | 0.34 | 0.43 | 0.77 |
| 1250° C. | 0.36 | 0.44 | 0.79 | 1.67 |
| 350 ppm Er₂O₃ | | | | |
| 1100° C. | 0.60 | 0.60 | 0.62 | 0.77 |
| 1150° C. | 0.60 | 0.62 | 0.74 | 1.27 |
| 1200° C. | 0.63 | 0.70 | 1.13 | 2.31 |
| 1250° C. | 0.73 | 0.98 | 1.94 | 4.15 |
| 100 ppm Y₂O₃ | | | | |
| 1100° C. | 0.57 | 0.57 | 0.60 | 0.76 |
| 1150° C. | 0.58 | 0.59 | 0.76 | 1.38 |
| 1200° C. | 0.61 | 0.70 | 1.22 | 2.54 |
| 1250° C. | 0.74 | 1.04 | 2.13 | 4.56 |
| 300 ppm MgO + | | | | |
| 50 ppm Er₂O₃ | | | | |
| 1100° C. | 0.54 | 0.54 | 0.57 | 0.76 |
| 1150° C. | 0.55 | 0.56 | 0.72 | 1.31 |
| 1200° C. | 0.58 | 0.67 | 1.16 | 2.42 |
| 1250° C. | 0.71 | 0.99 | 2.03 | 4.35 |

Resulting RIT values after 24 hours of annealing treatments are shown in Table IV. The annealing treatments were carried out at different temperatures as indicated in ° C.

TABLE IV

| Dopant (ppm) | After HIP | 1250° C. | 1275° C. | 1300° C. |
|---|---|---|---|---|
| 100 Y₂O₃ | 58 | 54 | | 38 |
| 1000 Y₂O₃ | 66 | 68 | | 61 |
| 350 Er₂O₃ | 57 | 54 | | 42 |
| 300 MgO + 50 Er₂O₃ | 56 | 51 | | 33 |
| 1200 La₂O₃ | 71 | | | 57 |
| 1000 MgO | 46 | 33 | | |
| 133 MgO | 44 | 35 | | |
| Reference | 45 | | 19 | |

The sample indicated as Reference in Table IV is formed from alumina without an additive or dopant.

Examples of discharge lamps having a discharge tube made of alumina according to the invention are described with reference to a drawing. The drawing shows a lamp 10 with a discharge tube 1 having a ceramic wall 2 of a transparent ceramic according to the invention. The lamp is provided with a partly broken away outer bulb 11. The discharge tube of the lamp is provided with electrodes 60, 70, which are connected to current conductors 13, 14 by leadthrough constructions 6, 7 known in the art. The current conductors are connected in a conventional way to electric contacts of a lamp base 12. In a first example, the discharge tube was made by slip casting of a slurry prepared, according to the process described above, with 2000 ppm La₂O₃. The lanthanum containing shaped body thus formed was sintered at a sinter temperature of 1350° C. during 2 hours, after which it was given an HIP treatment for 24 hours at a temperature of 1250° C.

In a second example, the discharge tube was made by slip casting of a slurry prepared, according to the process described above, with 300 ppm MgO. The magnesium-containing shaped body thus formed was sintered at a sinter temperature of 1220° C. during 2 hours, after which it was given an HIP treatment for 24 hours at a temperature of 1150° C.

The discharge tubes thus formed each have a ceramic wall with an average crystal size of 0.5 to 0.7 μm. In both examples of discharge tubes, the ceramic wall material showed a value for the RIT of at least 60%.

1. Polycrystalline alumina component with an additive characterized in that the alumina has an average crystal size ≦2 μm, and a relative density higher than 99.95% with a real in-line transmission RIT ≧30% measured over an angular aperture of at most 0.5° at a sample thickness of 0.8 mm and with a single wavelength of light λ, and that the additive comprises at least one of the substances from the group consisting of oxides of Mg, Y, Er and La.

2. Polycrystalline alumina component according to claim 1, characterized in that the additive is present in an amount of at least 10 ppm.

3. Polycrystalline alumina component according to claim 1, characterized in that the additive is Y₂O₃ in a quantity of at least 50 ppm and at most 1000 ppm.

4. Polycrystalline alumina component according to claim 1, characterized in that the additive contains Er₂O₃ in a quantity of at least 50 ppm and at most 5000 ppm.

5. Polycrystalline alumina component according to claim 1, characterized in that the additive is La₂O₃ in a quantity of at least 100 ppm and at most 5000 ppm.

6. Polycrystalline alumina component according to claim 1, characterized in that the additive is MgO in a quantity of at least 100 ppm and at most 1000 ppm.

7. Discharge lamp characterized in that the lamp is provided with a discharge tube having a wall of a ceramic as claimed in claim 1.

8. Lamp according to claim 6 characterized in that the discharge tube has an ionisable filling containing a metal halide.

9. Method for forming a polycrystalline alumina component as claimed in claim 1 characterized in that the process includes the steps of
preparing a slurry of corundum power with a mean grain size ≦0.2 μm,
adding a dopant, selected from a group formed by precursors containing one or more of the elements Mg, Y, Er and La and oxides of Mg, Y, Er and La,
casting the slurry in a mould,
drying and sintering of the moulded body thus formed, and
performing a HIP treatment at a temperature of at least 1150° C. for at least 2 hours.

10. Method according to claim 6 wherein after the addition of the dopant the prepared slurry is slip cast in a mould.
